(19) United States
(12) Patent Application Publication
(10) Pub. No.: US 2006/0074757 A1
(43) Pub. Date: Apr. 6, 2006

(54) Method and system for expediting coupon and rebate processing resulting in improving a user's credit rating

(76) Inventor: Romello Burdoucci, Nashville, TN (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 11/242,330

(22) Filed: Oct. 3, 2005

Related U.S. Application Data
(60) Provisional application No. 60/616,035, filed on Oct. 5, 2004.

(51) Int. Cl. G06Q 30/00

(52) U.S. Cl. 705/14

(57) ABSTRACT

A system operable over a computer network for decreasing a time period a customer waits to receive funds offered as a rebate when a product is purchased so that the rebate funds are used to improve the customer's credit rating, the system comprising a third-party fulfillment center responsible for providing rebate funds at an expedited rate to the customer, a financial acquisition network system for communicating between the fulfillment center and a financial provider institution to secure financial support with acceptable financial terms, a customer access system accessible by the third-party fulfillment center to allow the customer establish an account and manage the account including a fraud detection system, a financial account management system to allow the third-party fulfillment center to manage payments between the financial provider and the fulfillment center, a system for exchanging electronic versions of documents, and a communication system to allow the fulfillment center to communicate the customer and/or the financial provider.

This application claims priority of Provisional Patent Application Ser. No. 60/616,035, filed on Oct. 5, 2004, which is incorporated herein by reference.

### BACKGROUND OF THE INVENTION

This invention relates to coupons and rebate programs, and more specifically to a method and system for decreasing a time period a customer waits to receive the returned money offered by the rebate or coupon wherein the funds realized can be used as a basis to obtain a secured credit card and/or improve the user's credit rating.

Currently, manufacturer's and retailer's rebate offers associated with a particular product require that a consumer complete specific forms and submit those forms with proof of purchase information to a manufacturer's or retailer's fulfillment center for process verification and check or gift card issuance to the consumer for future discretionary spending. The traditional mail-in rebate process usually takes anywhere from four to twelve weeks and in some cases longer to process at a designated manufacturer's or retailer's fulfillment center.

In another current implementation, the manufacturers and retailers with attached rebates to their products allow for rebate processing to occur online through a third-party processor provider. This can be done by capturing consumer identification information for verification of rebate status and processing and using product transaction code information for proof of rebate entitlement. However, if the manufacturer and/or retailer do not have such a relationship with the online third-party processor, the user is left with utilizing the mail-in rebate procedure.

Under another implementation, the manufacturers and retailers utilize an instant rebate process that relies on an established relationship between a third party and the manufacturers and retailers for authentication of rebate status and processing while using a transaction code for adequate processing. This instant rebate usually occurs at the point of sale where the user realizes a reduced product or service price. The third party authenticates the instant rebate process by cross referencing transaction code data with that held in the manufacture or retailer's product or service database. However this approach also requires a relationship between the manufacturers and retailers and a third party.

However the most prevalent approach is still the use of mail-in rebates wherein users have to wait weeks prior to receiving the money due them from the rebate. Furthermore, rebate or money back from coupons are not usually available to use to improve the user's credit rating.

### BRIEF DESCRIPTION OF THE INVENTION

The present invention solves the above-stated problems in the art by providing a system, method, software program and online computer site for decreasing a time period a customer waits to receive the returned money offered by the rebate or coupon wherein the funds realized can be used as a basis to obtain a secured credit card and/or improve the user's credit rating.

Features of the invention can be implemented in numerous ways, including as a system, a method, a computer site, or a computer readable medium (e.g., software program). The invention preferably relies on a communications infrastructure, for example the Internet, wherein individual interaction is possible. Several embodiments of the invention are discussed below.

Part or all of the data can also be sent electronically and maintained on a web server for confidential access with typical browsers. The data may also be transmitted and viewed by other well-known techniques such as email, interactive television, and the like. The computer site is preferably viewed with a client web browser through a web secure server communicating with an application server having a database associated therewith.

Towards this end, a system operable over a computer network for decreasing a time period a customer waits to receive funds offered as a rebate when a product is purchased so that the rebate funds are used to improve the customer's credit rating is disclosed. The system comprising a third-party fulfillment center responsible for providing rebate funds at an expedited rate to the customer, and a financial acquisition network system accessible by the third-party fulfillment center for communicating with at least one financial provider institution to secure financial support with acceptable financial terms. A customer access system accessible by the third-party fulfillment center to allow the customer establish an account and manage the account, and a financial account management system to allow the third-party fulfillment center to manage payments between the financial provider and the fulfillment center are also part of the system.

The system further has a database storage server system accessible by the fulfillment center for retaining data relevant to the refund and a system for exchanging electronic versions of documents between at least two of the customer, the fulfillment center and the financial center. A fraud detection system accessible by the fulfillment center to determine whether the customer interacting through the customer access system is the correct user, a communication system to allow the fulfillment center to communicate with at least one of the customer and the financial provider, and a facsimile imaging system to allow the customer to transmit documents related to the refund to the fulfillment center are also element of the system.

A computer software program operable over a computer network for decreasing a time period a customer waits to receive funds offered as a rebate when a product is purchased so that the rebate funds are used to improve the customer's credit rating is also disclosed. The software program comprises a computer module for a computer for providing rebate funds at an expedited rate to the customer, a computer module for a computer for communicating with at least one financial provider institution to secure financial support with acceptable financial terms, and a computer module for a computer for establishing an account of the customer and managing the account of the customer.

The program further includes a computer module for a computer for managing payments between the financial provider and a fulfillment center, a computer module for a computer for retaining data relevant to the refund, and a computer module for a computer for exchanging electronic versions of documents between at least two of the customer, the fulfillment center and the financial center. Also included in the program are a computer module for a computer for determining whether the customer attempting to manage the account of the customer is the correct user, a computer module for a computer for communicating between the fulfillment center, the customer and/or the financial provider, and a computer module for a computer for transmitting images of documents related to the refund from the customer to the fulfillment center.

A method for decreasing a time period a customer waits to receive funds offered as a rebate when a product is purchased so that the rebate funds are used to improve the customer's credit rating is also disclosed. The software program comprises providing a fulfillment center to oversee distribution of rebate funds at an expedited rate to the customer, communicating between the fulfillment center and at least one financial provider institution to secure finances with acceptable financial terms, and creating an account of the customer.

The method further includes managing the account of the customer, managing payments between the financial provider and a fulfillment center, exchanging electronic versions of documents between at least two of the customer, the fulfillment center and the financial center, and determining whether the customer attempting to manage the account of the customer is the correct user. The method also includes communicating between the fulfillment center and at least one of the customer and the financial provider and transmitting images of documents related to the refund from the customer to the fulfillment center.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an exemplary illustration of elements that may be part of the present invention;

FIG. 2 is an exemplary embodiment of a flow chart illustrating exemplary steps used in setting up a new member account;

FIG. 3 is an exemplary embodiment of a flow chart illustrating the overall submission process of a rebate though the present invention;

FIG. 4 is an exemplary example of a web screen viewable by the user including the reminder track;

FIG. 5 is an exemplary embodiment of a flow chart illustrating an exemplary workflow process of the present invention;

FIG. 6 is an exemplary embodiment of wireless communication protocol between a mobile device, a store, and a fulfillment center;

FIG. 7 is an exemplary embodiment of a flow chart illustrating how funds from a rebate are submitted to a fulfillment center of the present invention;

FIG. 8 is an exemplary embodiment of a how coupons are used with the present invention;

FIG. 9 is an exemplary embodiment of a fax imaging server system process diagram as used in the present invention;

FIG. 10 is an exemplary embodiment of a process to bid on a rebate amount with a store or manufacturer; and

FIG. 11 is an exemplary embodiment of how interaction between the fulfillment center and the financial provider may occur.

It should be understood that in certain situations for reasons of computational efficiency or ease of maintenance, the ordering and relationships of the blocks of the illustrated flow charts could be rearranged or re-associated by one skilled in the art. While the present invention will be described with reference to the details of the embodiments of the invention shown in the drawings, these details are not intended to limit the scope of the invention.

### DETAILED DESCRIPTION

Reference will now be made in detail to the embodiments consistent with the invention, examples of which are illustrated in the accompanying drawings. Wherever possible, the same reference numerals used throughout the drawings refer to the same or like parts.

The present invention solves the problems in the art by providing a system, method, and online computer site for providing a comprehensive return on money owed from rebates and/or coupons providing users an ability to receive the money quicker, minus a processing fee, than usually typically provided by the entity providing the rebate, as well as an option to apply the rebate or coupon value to a secured credit line to improve a credit rating. Preferably, the invention is operated in conjunction with an interactive web site or stand-alone software program.

Persons skilled in the art will recognize that an apparatus, such as a data processing system, including a CPU, memory, I/O, program storage, a connecting bus, and other appropriate components, could be programmed or otherwise designed to facilitate the practice of the method of the invention. Such a system would include appropriate program means for executing the method of the invention.

Also, an article of manufacture, such as a pre-recorded disk or other similar computer program product, for use with a data processing system, could include a storage medium and program means recorded thereon for directing the data processing system to facilitate the practice of the method of the invention. Such apparatus and articles of manufacture also fall within the spirit and scope of the invention.

Broadly speaking, the invention provides a method, apparatus, and program for expediting the return of money from a rebate and/or coupon that is realizable to a user and/or providing a way for the user to improve a credit rating. To facilitate an understanding of the present invention, it is described hereinafter with reference to specific implementations thereof. The invention is described in the general context of computer-executable instructions, such as program modules, being executed by a computer. Generally, program modules include routines, programs, objects, components, data structures, etc. that perform particular tasks or implement particular abstract data types. For example, the software programs that underlie the invention can be coded in different languages, for use with different platforms. In the description that follows, examples of the invention are described in the context of a web portal that employs a web browser. It will be appreciated, however, that the principles that underlie the invention can be implemented with other types of computer software technologies as well.

Moreover, those skilled in the art will appreciate that the invention may be practiced with other computer system configurations, including hand-held devices, multiprocessor systems; microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

Referring now to the drawings, embodiments of the present invention will be described. The invention can be implemented in numerous ways, including as a system (including a computer processing system), a method (including a computerized method), an apparatus, a computer readable medium, a computer program product, a graphical user interface, including a web portal, or a data structure tangibly fixed in a computer readable memory. Several embodiments of the invention are discussed below. Furthermore, the scope of the invention disclosed is applicable to a plurality of uses, such as but not limited to other devices where money is due a party based on a financial transaction.

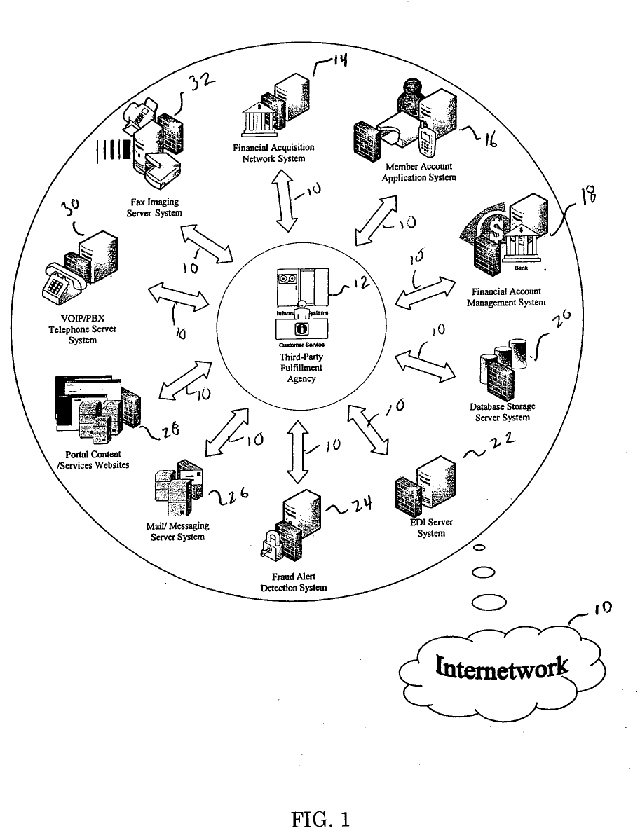

FIG. 1 is an exemplary embodiment of the network infrastructure used by a third-party fulfillment center to provide services pursuant to the present invention. In an exemplary embodiment the network operates over the Internet 10. In another exemplary embodiment, it can operate over a closed network. As illustrated various systems and/or computer software modules are accessible by a third-party fulfillment center, or agency, 12.

A financial acquisition network system (FANS), or computer module, 14 is provided. This system 14 is accessed to communicate with financial provider institutions to secure financial support at preferred or favorable interest rates. A member account application system, or computer module, 16 is also provided. With this module 16, a user can set up an account and manage the account. The third-party fulfillment center 12 can also send information from any of the other networked modules to this module 16 that the user needs to view.

The financial account management system (FAMS), or module, 18 is provided to allow the third-party fulfillment agency 12 to manage payments between the financial provider and the fulfillment center 12. The database storage server system (DSSS) 20 is used to retain all records, reports, etc. The EDI server system (EDISS) 22 is used to complete electronic data interchange (EDI) transactions. EDI is an application-to-application exchange of standard business documents in an electronic format between two entities. A fraud alert detection system (FADS), or module, 24 is provided and is used to determine whether the user interacting with the present invention is the correct user.

A mail/messaging server, or module, 26 is provided. As discussed in more detail below, this module 26 is used to send messages to the user, usually at an email address that the user provides. A portal content/services website 28 is also provided. This is used to build and maintain websites used by the fulfillment center 12. A voice-over-IP/PBX telephone server system 30 is provided. This is used for communicating in voice to outside entities, even including the user. A fax imaging server system (FASS) 32 is provided. As discussed in more detail below this system 32 is used to collect actual document images provided from the user.

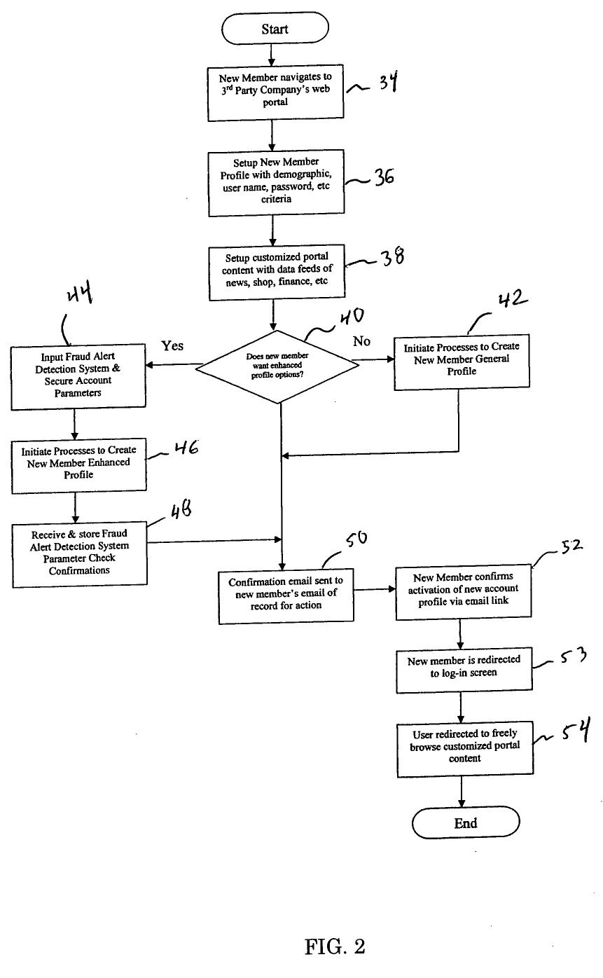

FIG. 2 is an exemplary embodiment of a flow chart illustrating exemplary steps used in setting up a new member account. As illustrated when starting, a new user first navigates to the fulfillment center's web site, step 34. There, the user enters a web page that allows the user to enter information, step 36. In an exemplary embodiment this page is provided over a secure network. The type of information that may be required from the user includes, but is not limited to name, address, phone number, a user name, password, email address, etc. Those skilled in the art will readily recognize that the password may be created by the user or by the fulfillment center. In an exemplary embodiment, the user will also answer questions regarding likes/dislikes, step 38. Based on this information customized portal content will be provided whenever the user ever logs onto the system 16. For example, if the user signifies that the user enjoys sports, then the latest news regarding events in the sporting world will be displayed to the user. The user then has a decision to make as to whether to create an enhanced profile, step 40. If the answer is no, a general profile is created, step 42. If an enhanced profile is desired, then the user inputs data required by the input fraud alert detection system and secure account parameters, step 44. Such information may include, but is not limited to, credit card numbers, bank account numbers, and other numbers associated with such personal data, and social security card numbers. The information is processed to create a new member enhanced profile, step 46. The information is then stored for later use to verify the user, step 48. Regardless of whether or not an enhanced profile is created, the system next sends a confirmation email to the email address provided by the user, step 50. The new user then confirms activation of the new account via email, step 52. The new user is then directed to a login screen, step 53, where the user can freely browse the customized portal for content, step 54.

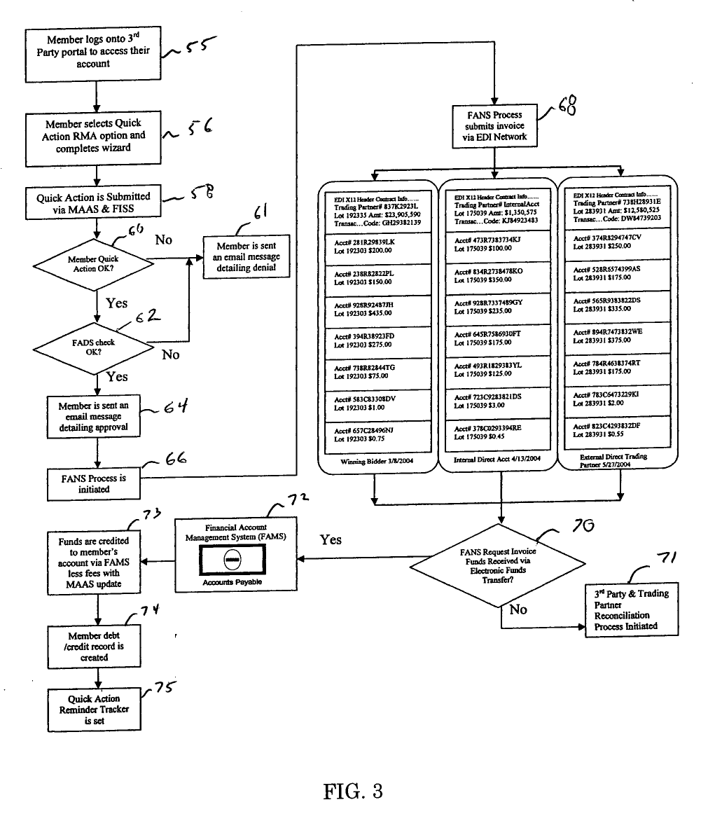

FIG. 3 is an exemplary embodiment of a flow chart illustrating the overall submission process of a rebate though the present invention. In this situation, the user has purchased a product and has rebate information that must be submitted to a manufacturer authorized center. The user logs onto the fulfillment center's website to access the user's account, step 55. One of the options on the user's account is to select a quick action remittance member action, step 56. Here, the user fills out information regarding the rebate offer. The user submits this information through the member account application system and through the fax imaging server system, step 58. With respect to the fax imaging server system, a copy of the documents that accompany the rebate are faxed to the fulfillment center. Once submitted, the fulfillment center makes a decision whether to accept the submittal for processing, step 60. If not accepted the user is sent an email message detailing why the submittal was denied, step 61. If accepted, the fraud alert detection system determines whether the user is authentic, step 62. If not authentic, a message is sent to the user explaining why not, step 61. If accepted, the member is sent an email detailing approval, step 64.

Next the financial acquisition network system is initiated, step 66. The financial acquisition network submits rebate amounts to a number of ways to prospective and actual financial institutions over the EDI network, step 68. As illustrated, step 69, the rebate amounts are bundled together to assist the fulfillment center in obtaining the best available financial terms when seeking the up front rebate funds from a financial institution. This may be accomplished using micro-payments and/or bundling smaller fund amounts to create a larger fund amount.

Based on the financial terms for receipt of the money, the fulfillment center decides whether to accept the funds, step 70. If the financial terms, such as interest rate, are unacceptable, the invoice is resubmitted for further consideration, step 71. If accepted, the financial account management system is accessed and the money is distributed to the user, steps 72, 73, 74. The funds are credited to the user's account, less applicable fees, step 73. A member debit/credit record is created, step 74. The quick action reminder tracker is set, step 75. This tracker is used to remind the user when the rebate amount received from the manufacturer should be repaid to the fulfillment center.

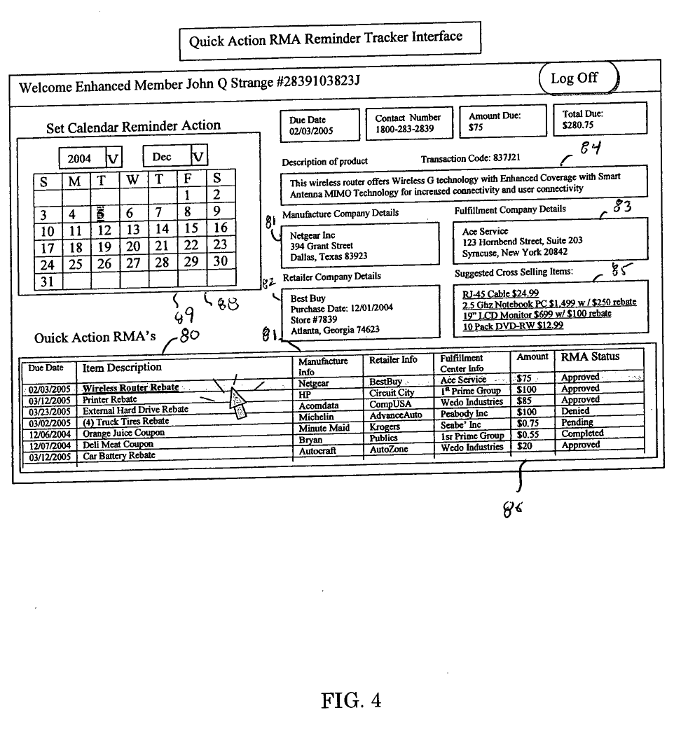

An exemplary example of a web screen viewable by the user including the reminder track is provided in FIG. 4. As illustrated, information regarding rebates, including item purchased 80, manufacture 81, store location 82, manufacture rebate fulfillment center 83, product description 84, cross selling items based on rebated purchase 85, and amount of the rebate 86 is also provided. A calendar reminder 88 is part of the reminder tracker 89 where expected due dates for receipt of rebates can be programmed into the system based on other information provided though the portal, or the user can mark a reminder directly.

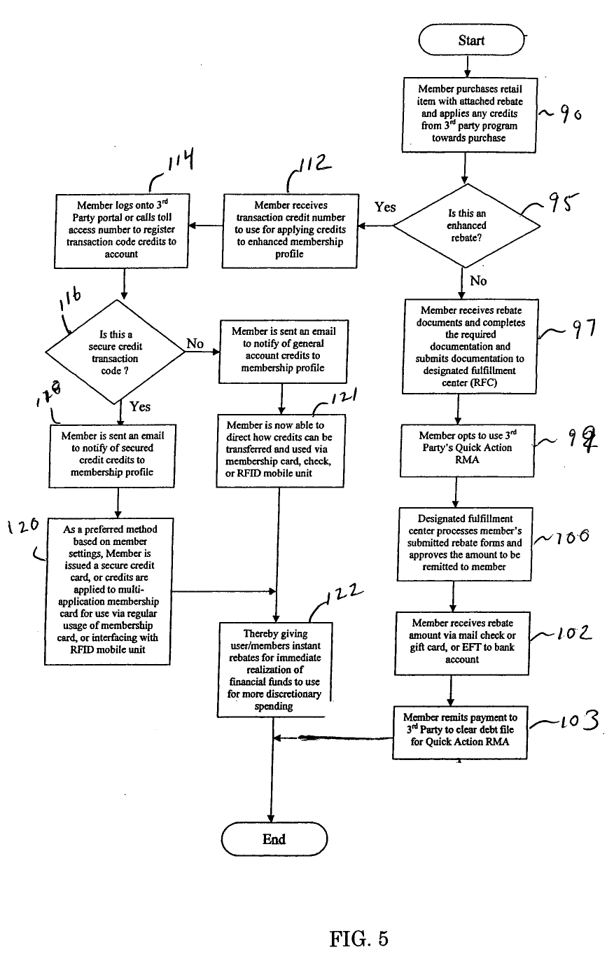

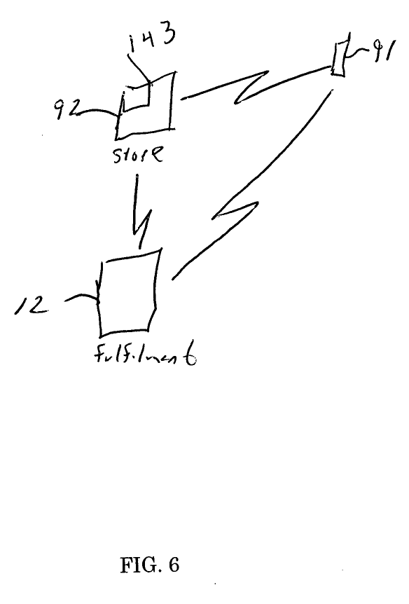

FIG. 5 is an exemplary embodiment of a flow chart illustrating an exemplary workflow process of the present invention. As illustrated, the user purchases a retail item that has a rebate attached to it, step 90. If the user already has credit accumulated from prior purchases the user can use that credit towards this current purchase. The accumulated credit may be available on a secured credit card that was provided to the user by the fulfillment center. In another exemplary embodiment, a mobile device 91, such as a mobile phone with radio frequency identification technology (RFID), Bluetooth technology, or another wireless communication protocol, may provide the communication medium between the user, the retailer's financial transaction system 92, and the fulfillment center 12 to insure that credit and debit are properly passed between these entities, as illustrated further in FIG. 6.

If the rebate is not an enhanced rebate, step 95, or in other words one which can be instantly taken at the time of purchase, the user receives the rebate documents and completes them and submits them to the fulfillment center with a copy (or the original) also being sent to the manufacturer rebate center, step 97. The user uses the quick action RMA, step 99. The user is provided the rebate, less fees, from the fulfillment center, step 99. Meanwhile, the manufacture rebate center processes the rebate in the time designated for receipt of the rebate, usually several weeks, step 100. The user then receives the rebate funds via a check through the mail, gift card, or directly to a bank account, step 102. The user then remits the rebate to the fulfillment center to clear the debt owed the fulfillment center by the fulfillment center providing rebate funds, less a processing fee, as soon as the user sought these funds from the fulfillment center, step 103.

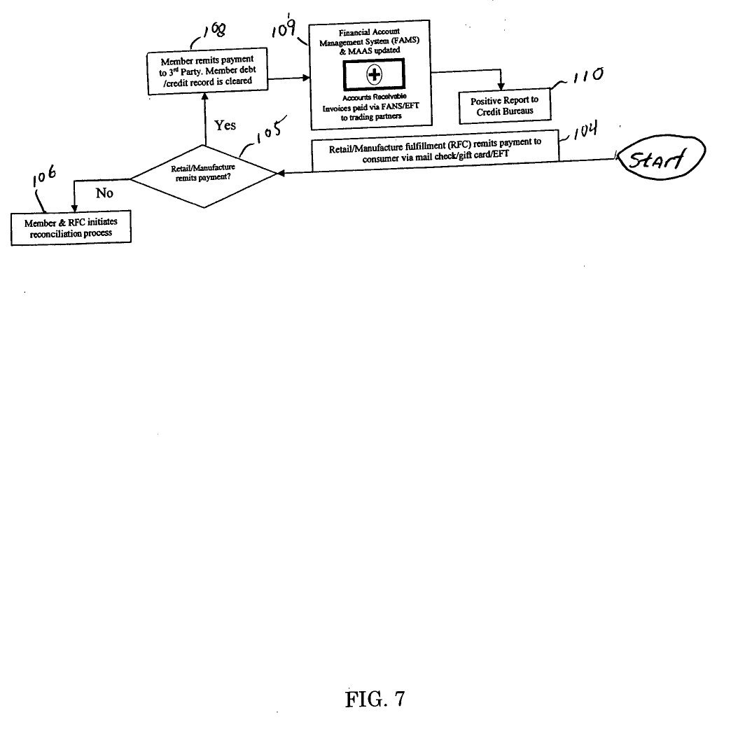

As illustrated in FIG. 7, steps 102, 103 are further detailed. Once the manufacture rebate center remits the rebate to the user, step 104, within the present invention a decision gate is provided as to determine whether payment has been remitted to the fulfillment center, step 105. This decision gate is integrated to the tracker, 89 so that the fulfillment center 12, based on information it has regarding the expected return of the rebate check from the manufacturer, knows when to expect repayment. If repayment is not received, step 106, the user is contacted to determine the status of repayment. Those skilled in the art will readily recognize that other actions can be taken as well if the user fails to pay the debt owed the fulfillment center. If payment is made, the user's debt record is cleared, step 108. The FAMS 18 and MAAS 16 systems' records are updated, and invoices are paid to the financial entity providing the funds to cover the rebate, step 109. A positive report is also sent to the credit bureaus regarding the user, step 110.

As further illustrated in FIG. 5, if the rebate is an enhanced rebate, the user receives the rebate credit sooner because the user receives a tracking number to report to the fulfillment center, step 112. The user either logs into the fulfillment center to register the tracking number, or transaction code, or can call a toll free access number to report the number or code, step 114. In another exemplary embodiment, as discussed above, the RFID phone, or using Bluetooth or any other wireless communication protocol, can report and receive credits for later use, as illustrated in FIG. 6. Towards this end, instead of immediately taken the rebate at the cash register, the user pays the non-rebated price for the purchase. The rebate is then used to provide credit to the user. By doing this, the user has credit which may offset other rebate debts still owed the fulfillment center and thus the debt is paid off sooner and in turn reported favorably to the credit bureaus.

If the transaction is using the user's secured credit card, step 116, and a secured transaction code is provided, the user is sent an email to notify of secured credit credits being applied to the card, steps 118, 120. The user may either use the secured credit card or pay using the cell phone as discussed above. If there is no secure credit transaction code provided, the user is sent an email notifying the user of general account credits available for later use, step 117. The user is then able to direct how the credit is to be used, step 121. This process results in the user having instant rebate credits for use later or immediately wherein the credits are used to show payment on existing debts which is in turn reported to the credit bureaus, step 122.

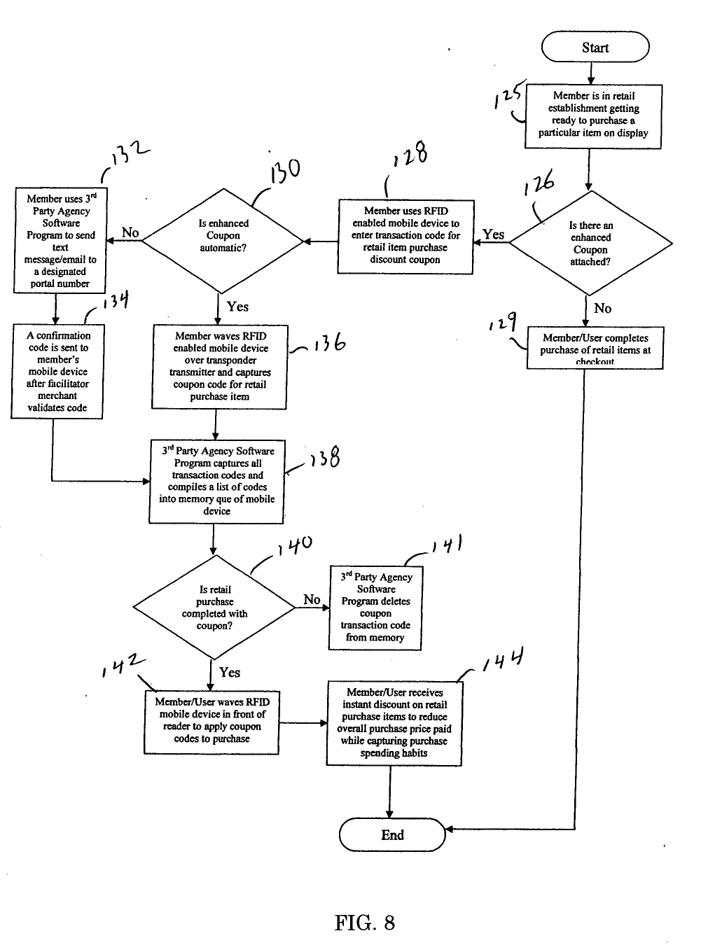

FIG. 8 is an exemplary embodiment of a how coupons are used with the present invention. As with the instant rebates, the intent here is for the user to receive monetary credit for coupons instead of simply realizing the discount at the register. Once the user selects an item for purchase, step 125, and the item includes an instant coupon, step 126, the user may use the mobile unit 91 discussed above to enter a transaction code for the discount coupon, step 128. This may occur at the shelf where the product is shelved or at checkout. If an enhanced coupon is not attached, the user checks out as usual, step 129.

If the enhanced coupon is not automatic, step 130, the member, or user contacts a designated portal number, step 132. A confirmation code is sent to the member's mobile device once a merchant validates the code, step 134. If the enhanced coupon is automatic, step 130, the user, or customer, waves, or passes, the mobile device over a communication device, such as a transponder which transmits and captures coupon code for the purchase item, step 136. The fulfillment center captures all transaction codes and compiles a list of codes in a memory que of the mobile device 91, step 138.

Next a determination is made whether the purchase is completed with the coupon, step 140. This is requires coordination between the store's financial system and fulfillment center especially when coupon information is entered prior to the user reaching a check-out stand. If the coupon is not used, then the coupon transaction code is erased from the mobile device's memory and from through the system, step 141.

If the coupon is used, step 140, the user waves the mobile device 91 in front of a reader 143 to apply the coupon code to purchase, step 142. The user receives the instant discount on the purchased product, step 144. In another exemplary embodiment, the instant discount is not taken and instead, the credit is applied to the user's secured credit card or credit line for later use. By doing so, a favorable report can be generated and sent to the credit bureaus.

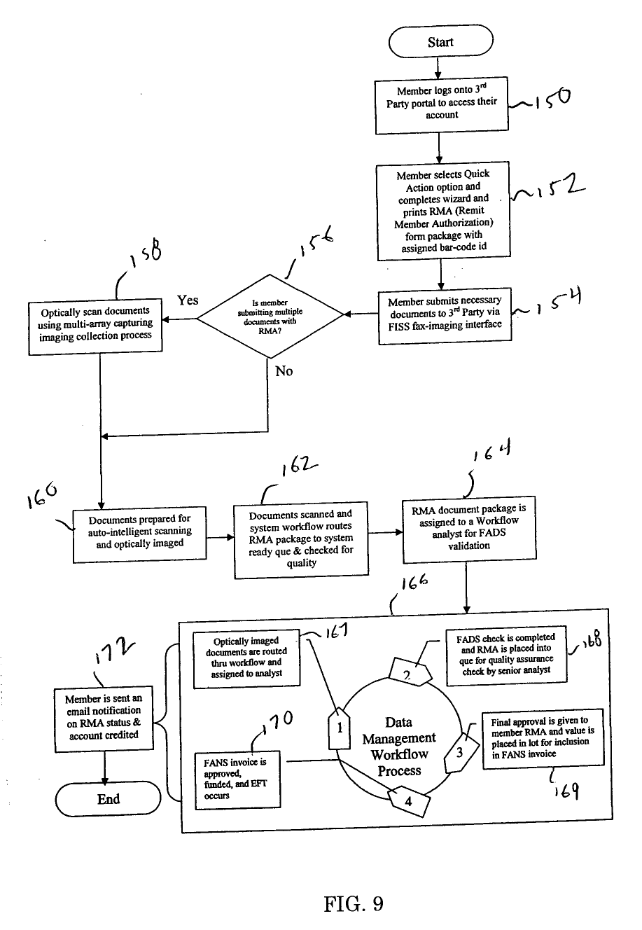

FIG. 9 is an exemplary embodiment of a fax imaging server system process diagram as used in the present invention. As illustrated, the user logs onto the fulfillment center's web site to access the user's account, step 150. When the user selects the quick action option, the user then completes the forms and prints a remit member authorization form package, step 152. In an exemplary embodiment this package includes an assigned bar-code identification. The user then uses a facsimile machine to submit the necessary documents to the fulfillment center, step 154. A determination is made as to whether more than one submission is being faxed from the user, step 156. In an exemplary embodiment, this can be done based on page count wherein the number of required documents is preprogrammed into the system. Those skilled in the art will readily recognize other ways in which the number of submittals may be identified.

If more than one submission is being faxed, a multi-array capturing imaging collection process is used to distinguish the submissions, step 158. Once received the documents are prepared for scanning which will result in having an optical image, step 160. The images are checked for quality of the image, step 162. The scanned documents are assigned for analysis for validation, step 164. During the validation process, the documents are first assigned for analysis, step 167, and then set for secondary validation, such as by a senior analyst, step 168. This is followed by approval and submission to the financial acquisition network system, or module, step 169. Once the funds are approved they are provided to the user as credit, step 170. The user is sent notification of the status, step 172.

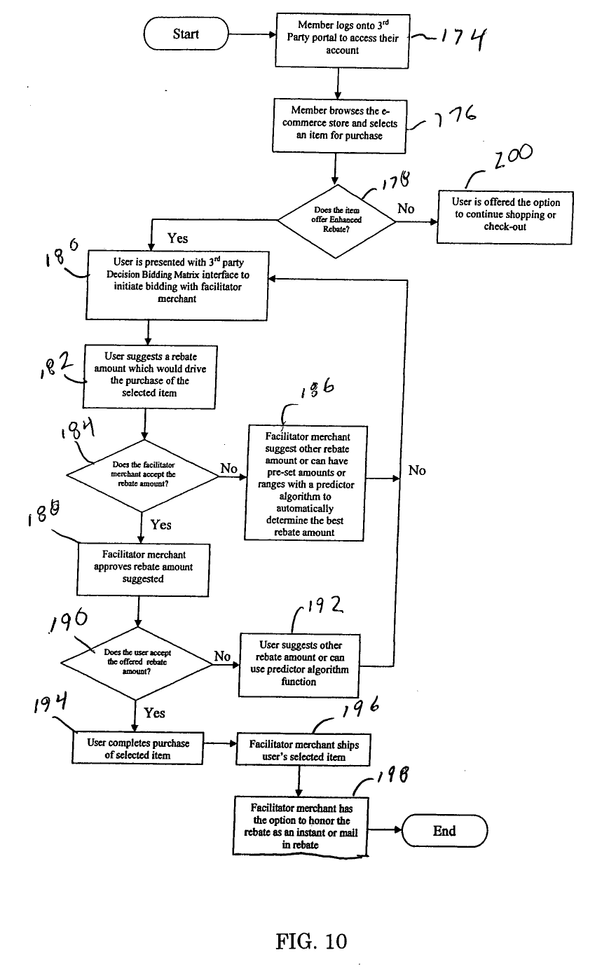

FIG. 10 is an exemplary embodiment of a process to bid on a rebate amount with a store or manufacturer. The user logs onto the user's account, step 174. If on-line shopping, the user selects an item to purchase, step 176. The same holds true if shopping in a brick and mortar store. If an enhanced rebate is available for the product to be purchased, step 178, the user is provided access to a bidding matrix interface to initiate bidding, step 180. This interface may be provided through a store kiosk and/or through the phone discussed above. The user initiates the process by asking for a rebate amount, step 182. If the store and/or manufacturer (merchant facilitator) does not accept the rebate amount, step 184, the merchant facilitator can counter or the user can submit another bid, step 186. If the bid amount is accepted, step 188, the user has a final option to accept or reject the accepted offer, step 190. If the rebate amount is rejected, step 190, the process begins again, step 192. If accepted, step 190, the user completes the purchase process, step 194. If the bid process is for a product purchased from an e-commerce provided, the product is then shipped to the user, step 196. As part of the bid process, a decision whether to honor the rebate as a mail-in-rebate or an instant rebate may also be determined. In another exemplary embodiment that decision is made solely by the merchant facilitator, step 198. If enhanced rebate is not available, the user simply continues shopping or checks out, step 200.

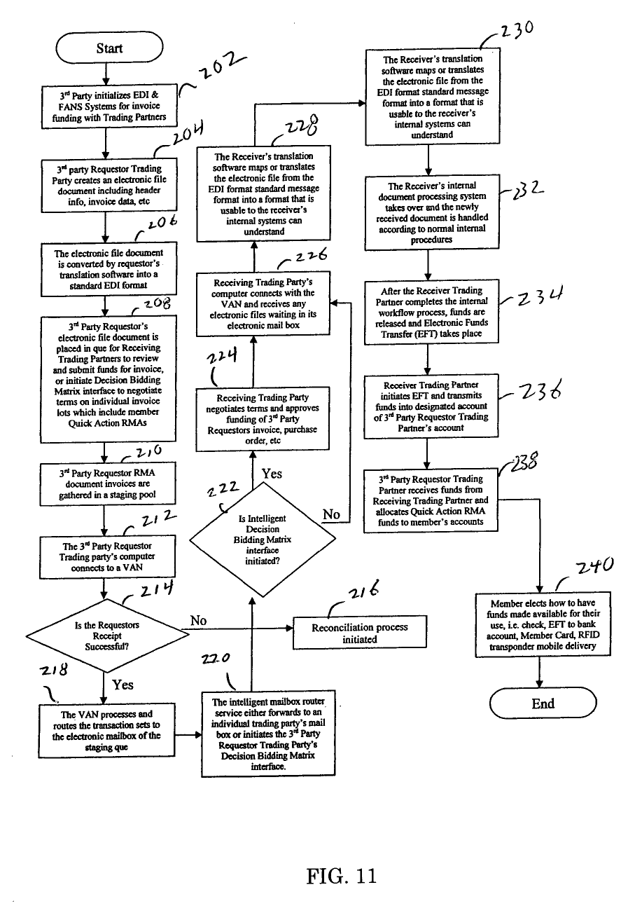

FIG. 11 is an exemplary embodiment of how interaction between the fulfillment center and the financial provider may occur. As illustrated the fulfillment center initiates the EDI and FANS systems, or computer modules, for invoice funding with respective trading partners, which are usually financial institutions, step 202. The fulfillment center creates an electronic file document including headers, information, etc, step 204. The document is converted into standard EDI format, step 206. The form is placed in a cue for financial institutions to review, step 208. At this stage, depending on the arrangement with financial institutions a number of events may occur. If a financial institution, or institutions have already negotiated financial rates with the fulfillment center the next in line financial institution is provided the form to complete the transaction. If there is no pre-arranged agreement, the financial institutions can bid and/or negotiate terms on individual invoice lots, which may include quick action RMAs over a peer-to-peer transaction network.

After the invoices are gathered in a staging area, step 210, the fulfillment center connects to value added network which is part of the EDI system, step 212. If the fulfillment center 12 and any bidders, and/or financial institutions cannot agree upon financial terms, step 214, the process is started again, step 216. If there is an agreement, step 214, the invoices are routed to the appropriate financial institution, step 218. If the bidding matrix is utilized, step 222, the financial terms are bided on by financial institutions, step 224. The winning financial institution then processes the invoices and submits funds to the fulfillment center for distribution to the user, steps 226, 228, 230, 232, 234, 236, 238, 240. Though exemplary steps are shown regarding how the financial institution processes and submits the funds, those skilled in the art will readily recognize that other steps may be utilized to accomplish the same goal.

While the invention has been described in what is presently considered to be a preferred embodiment, many variations and modifications will become apparent to those skilled in the art. Accordingly, it is intended that the invention not be limited to the specific illustrative embodiment but be interpreted within the full spirit and scope of the appended claims.

What I claim is:

1. A system operable over a computer network for decreasing a time period a customer waits to receive funds offered as a rebate when a product is purchased so that the rebate funds are used to improve the customer's credit rating, the system comprising:
a) a third-party fulfillment center responsible for providing rebate funds at an expedited rate to the customer;
b) a financial acquisition network system accessible by the third-party fulfillment center for communicating with at least one financial provider institution to secure finances with acceptable financial terms;
c) a customer access system accessible by the third-party fulfillment center to allow the customer establish an account and manage the account;
d) a financial account management system to allow the third-party fulfillment center to manage payments between the financial provider and the fulfillment center;
e) a database storage server system accessible by the fulfillment center for retaining data relevant to the refund;
f) a system for exchanging electronic versions of documents between at least two of the customer, the fulfillment center and the financial center;
g) a fraud detection system accessible by the fulfillment center to determine whether the customer interacting through the customer access system is the correct user;
h) a communication system to allow the fulfillment center to communicate with at least one of the customer and the financial provider; and
i) a facsimile imaging system to allow the customer to transmit documents related to the refund to the fulfillment center.

2. The system of claim 1 wherein the financial acquisition network system further comprises an ability for financial institutions to bid on financial terms for at least one of rebate funds and groups of rebate funds that the fulfillment center seeks to provide to the customer in advance of the customer receiving the rebate funds from at least one of a manufacturer and a store where the product was purchased.

3. The system of claim 1 wherein the customer access system further comprises allowing the user to submit a request to obtain a secured credit card wherein advance rebate funds supplied to the customer are distributed to the secured credit card as credit.

4. The system of claim 1 further comprises a reminder tracker to notify the customer approximately when rebate funds are due from at least one of the manufacturer and the store so that the rebate funds can be distributed to the fulfillment center to repay a debt resulting from the fulfillment center providing advance rebate funds to the customer.

5. The system of claim 1 further comprises a mobile device that connects with the fulfillment center and a store's financial system with a wireless protocol so as to allow credits and debits associated with the purchase of the product to be applied accordingly.

6. The system of claim 1 wherein the rebate is a coupon and a financial amount of the coupon is credited to the customer to improve the customer's credit rating.

7. The system of claim 6 wherein the financial amount of the coupon is initially credited to the customer and then applied to the product sales price when the product is purchased.

8. A computer software program operable over a computer network for decreasing a time period a customer waits to receive funds offered as a rebate when a product is purchased so that the rebate funds are used to improve the customer's credit rating, the software program comprising:
a) a computer module for a computer for providing rebate funds at an expedited rate to the customer;
b) a computer module for a computer for communicating with at least one financial provider institution to secure financial support with acceptable financial terms;
c) a computer module for a computer for establishing an account of the customer and managing the account of the customer;
d) a computer module for a computer for managing payments between the financial provider and a fulfillment center;
e) a computer module for a computer for retaining data relevant to the refund;
f) a computer module for a computer for exchanging electronic versions of documents between at least two of the customer, the fulfillment center and the financial center;
g) a computer module for a computer for determining whether the customer attempting to manage the account of the customer is the correct user;
h) a computer module for a computer for communicating between the fulfillment center and at least one of the customer and the financial provider; and
i) a computer module for a computer for transmitting images of documents related to the refund from the customer to the fulfillment center.

9. The software program of claim 8 further comprises a computer module for a computer for biding on financial terms for at least one of rebate funds and groups of rebate funds that the fulfillment center seeks to provide to the customer in advance of the customer receiving the rebate funds from at least one of a manufacturer and a store where the product was purchased.

10. The software program of claim 8 further comprises a computer module for a computer for submitting a request to obtain a secured credit card wherein advance rebate funds supplied to the customer are distributed to the secured credit card as credit.

11. The software program of claim 8 further comprises a computer module for a computer for notifying the customer approximately when rebate funds are due from at least one of the manufacturer and the store so that the rebate funds can be distributed to the fulfillment center to repay a debt resulting from the fulfillment center providing advance rebate funds to the customer.

12. The software program of claim 8 further comprises a computer module for a computer for connecting a mobile unit held by the customer with the fulfillment center and a store's financial system over a wireless protocol so as to allow credits and debits associated with the purchase of the product to be applied accordingly.

13. The software program of claim 8 further comprises the rebate being a coupon and a financial amount of the coupon is credited to the customer to improve the customer's credit rating.

14. A method for decreasing a time period a customer waits to receive funds offered as a rebate when a product is purchased so that the rebate funds are used to improve the customer's credit rating, the software program comprising:
a) providing a fulfillment center to oversee distribution of rebate funds at an expedited rate to the customer;
b) communicating between the fulfillment center and at least one financial provider institution to secure finances with acceptable financial terms;
c) creating an account of the customer;
d) managing the account of the customer;
e) managing payments between the financial provider and a fulfillment center;
f) exchanging electronic versions of documents between at least two of the customer, the fulfillment center and the financial center;
g) determining whether the customer attempting to manage the account of the customer is the correct user;
h) communicating between the fulfillment center and at least one of the customer and the financial provider; and
i) transmitting images of documents related to the refund from the customer to the fulfillment center.

15. The method of claim 14 further comprises retaining data relevant to the refund.

16. The method of claim 14 further comprises biding on financial terms for at least one of rebate funds and groups of rebate funds that the fulfillment center seeks to provide to the customer in advance of the customer receiving the rebate funds from at least one of a manufacturer and a store where the product was purchased.

17. The method of claim 14 further comprises submitting a request to obtain a secured credit card wherein advance rebate funds supplied to the customer are distributed to the secured credit card as credit.

18. The method of claim 14 further comprises notifying the customer approximately when rebate funds are due from at least one of the manufacturer and the store so that the rebate funds can be distributed to the fulfillment center to repay a debt resulting from the fulfillment center providing advance rebate funds to the customer.

19. The method of claim 14 further comprises connecting a mobile unit held by the customer with the fulfillment center and a store's financial system over a wireless protocol so as to allow credits and debits associated with the purchase of the product to be applied accordingly.

20. The method of claim 14 further comprises the rebate being a coupon and a financial amount of the coupon is credited to the customer to improve the customer's credit rating.
